(19) United States
(12) Patent Application Publication
(10) Pub. No.: US 2019/0059642 A1
(43) Pub. Date: Feb. 28, 2019

(54) JACKETED HEAT-RETAINING VESSEL

(71) Applicant: Dipankar ., Mumbai (IN)

(72) Inventor: Dipankar ., Mumbai (IN)

(21) Appl. No.: 16/174,267

(22) Filed: Oct. 29, 2018

Related U.S. Application Data
(63) Continuation of application No. PCT/IN2017/050143, filed on Apr. 24, 2017.

(30) Foreign Application Priority Data
Apr. 27, 2016 (IN) 201621014646

(51) Int. Cl. A47J 36/36; A47J 27/00; H05B 6/12

(52) U.S. Cl. CPC A47J 36/36; H05B 6/1209; A47J 27/004

(57) ABSTRACT

A jacketed heat-retaining vessel includes a pre-designed heat-retention jacket configured to envelope a vessel, wherein the heat-retention jacket comprising embedded heat delivery mechanisms in order to provide heat to said enveloped vessel; and said jacket comprises at least one layer of insulating material and at least one layer of radiation reflective material alternatively interspersed along a radially outward direction from the vessel center.

### RELATED APPLICATIONS

This application claims priority under 35 U.S.C. § 120 to, and is a continuation of, co-pending International Application PCT/IN2017/050143, filed Apr. 24, 2017 and designating the US, which claims priority to Indian Application 201621014646, filed Apr. 27, 2016, such Indian Application also being claimed priority to under 35 U.S.C. § 119. These Indian and International applications are incorporated by reference herein in their entireties.

### FIELD

Example embodiments relate to the field of thermal engineering, optical engineering, and electromagnetic engineering, particularly, heat-retaining vessels.

### BACKGROUND

The world is facing a huge crisis. Most of the energy we use today and take for granted, is obtained from fossil fuels, directly or indirectly. The world now consumes 97 million barrels of oil per day (1 barrel is approximately 160 liters), or 180,000 liters per second, and the demand is growing rapidly.

People are waking up to the realization that the days of cheap oil based energy are over.

Peak oil is a reality that we see around us today (demand surpassing production capacity). Oil companies are trying to dig deeper into the ocean (with exponential rise in cost, as a function of depth of exploration) to find oil. They are not doing this for fun, but the reality is that cheap oil sources have dwindled. What happened in the Gulf of Mexico a few years ago is an example of human-inflicted catastrophes from oil-rig disasters. These are still fresh in our memory.

Other sources of energy, such as nuclear energy has its own perils, as is evidenced from the number of nuclear plant disasters that happened in recent history (Chernobyl, Three Mile Island, Fukushima, etc., being the poster candidates highlighting the perils involved with nuclear energy). The bottom line is that the world at large still does not know how to deal with nuclear energy safely, including storing or disposing off of the spent nuclear fuel, which would continue to be radioactive for thousands of years.

The emergence of thinking on safer, and renewable sources of energy is therefore not by accident. People are exploring solar PV, solar thermal, wind, tidal, geothermal, etc, as other viable sources of renewable energy. However, one thing is clear. Whatever be the source for the renewable energy, we cannot afford to squander what we are generating.

Energy is precious. Energy is the true currency for wealth.

The world is in dire need for energy efficient solutions. Almost every aspect of our modern existence is dependent on energy. Most of the energy we use today is still derived from fossil fuel sources. Thus energy efficient products and solutions are among the most important things to consider in our times ahead.

Even for our basic survival needs, say for cooking, we use energy. In developing and underdeveloped countries and societies, the energy requirement for cooking is very significant fraction of the total energy needs. In India for example, the middle class is still largely dependent on LPG and kerosene for cooking. An average household of four consumes one cylinder a month or 12 cylinders in a year or 170 kg of LPG. Government of India spends nearly Rs.20,000-40,000 crores annually (or approximately US$3-6 billion) on LPG subsidies alone. Similar figures appear for kerosene as well. The actual cost (beyond subsidies) is a factor of 2-3 times larger as compared to the subsidies. Thus this is a very large problem, and any significant solution in this regard would be a game changer.

There are many studies and projects that have attempted to create “energy efficient stoves”. In the African context, women are primarily responsible for gathering firewood, and they need to go far. This makes them vulnerable and crimes like rape, abduction and assault are common. According to some studies done in Berkeley, three billion people cook meals over open fires each day creating pollution that kills 4.3 million people each year. The biomass (wood, animal dung and crop residue) used as fuel gives off toxic smoke at about seven times the safe limit set by the U.S. Environmental Protection Agency, (EPA). Studies also indicate that wood used as a cooking fuel results in nearly half of worlds' deforestation. The very process of gathering and carrying firewood for long distances, itself results in medical problems such as severe neck and back injuries.

Another approach to solve the problem of energy needs for cooking has been attempted with a variety of solar cookers. These come in various forms. From box-type, with glass top, panel-type with several reflecting panels directing heat to the cooking zone, or even parabolic reflector based stoves or steam generating methods, there are have been many independent attempts to solve the problem of cooking by using the energy from the Sun directly.

However, in spite of these laudable attempts to solve a major problem, most of these solutions are primarily implementations of energy efficient wood burning stoves, whose primary users are rural communities. As noted above, firewood based cooking has its own set of problems. An even more important question is how to address cooking energy needs of the increasing urban (or urbanized) population around the globe.

The cooking stove's energy efficiency has been the focus of a fair number of scientists, but then it is only a part of the energy efficiency equation.

Comparatively much less work appears to address energy efficiency aspects of the cooking pot itself. Traditionally, the pressure cooker has been projected as an energy efficient device. But even in this case, an open gas flame tends to deliver only about 20% of the combustion energy to the pot, including a pressure cooker. Flat bottomed cookware allows for more contact with heating elements, which in turn more effectively heats your pan. A warped-bottom pot could take 50% more energy to boil water than its flat bottomed counterparts. Relatively fewer research interests have directed attention to the cooking pot itself. Slow-cooking aids such as Wonderbags are also helpful.

Overall, there is a significant void in this sector. The vast energy wastage from our daily cooking itself can be arrested immediately.

In all traditional cooking methods, there is heat (energy) loss from the cooking process itself. Any object raised to a higher temperature would lose heat by the processes of conduction, convection and radiation. Other processes, such as phase-changes, say water escaping as steam, would also lead to losses. Heat is also sometimes lost due to mass transfer, say when we drain off water from boiled rice, discarding it.

Additionally the efficiency of energy transfer from the heating source (stove or oven for example) to the cooking container is often inefficient. For example, in the case of a pot on a gas stove, only about 20% of the energy of combustion from the burning gas gets transferred to the pot.

There are many other indirect energy costs associated with any fuel source too. For example, a cylinder of gas needs to be physically brought in to a user, and this would happen by transporting them on trucks from the filling stations to the distributors and then to the homes. Careful analysis reveals that great amount of energy is lost in standard cooking processes.

Much of cooking appears to use the following basic processes, in different temperature ranges:
Boiling: This includes boiling, steaming, stewing, blanching, etc. This involves cooking ingredients in watery medium. Thus the temperature of the cooking process occurs around 100 degrees Celsius.
Thermal Cooking: Cooking at temperatures in 80-100 degrees Celsius. This is also called slow cooking, and is important for many different types of food (rice, lentils/pulses, soups, etc).
Frying: This includes deep frying, pan-frying, sauté, etc. The temperature of frying is typically around 170-200 degree Celsius.
Baking: Oven air temperature should be around 170-235 degree Celsius for different kinds of baked foods (breads, biscuits, cakes, etc).

### SUMMARY

Example embodiments include a jacketed heat-retaining vessel including:
a pre-designed heat-retention jacket configured to envelope a vessel, characterized in that, the heat-retention jacket including embedded heat delivery mechanisms in order to provide heat to the enveloped vessel; and
the jacket comprises at least one layer of insulating material and at least one layer of radiation reflective material alternatively interspersed along a radially outward direction from the vessel center.

Typically, the jacket comprises a plurality of sheets of radiation reflective material in concentric configuration with respect to the vessel.

Typically, the jacket comprises a plurality of sheets of radiation reflective material in a spiral configuration with respect to the vessel.

Typically, the radiation reflecting layer is formed in a continuous series of loops in a layered forms about a cylindrical axis of the vessel.

Typically, the radiation reflecting layer is formed in a non-continuous series of loops in a layered forms about a cylindrical axis of the vessel.

In at least one embodiment, the insulating layer is formed in a continuous series of loops in a layered form about a cylindrical axis of the vessel.

In at least one embodiment, the insulating layer is formed in a non-continuous series of loops in a layered form about a cylindrical axis of the vessel.

In at least one embodiment, the jacket is a passive heat-retaining jacket.

In at least one embodiment, the jacket comprises multiple layers of insulating material with radiation reflective layers interspersed between the insulating materials.

In at least one embodiment, the jacket comprises at least one layer of insulating material and at least one layer of radiation reflective material, characterized in that, the radiation reflective layer is any reflective layer.

In at least one embodiment, the vessel including a bottom shield for the predesigned heat-retention jacket which covers the embedded induction coils.

In at least one embodiment, the vessel including a bottom shield for the predesigned heat-retention jacket which covers an energy source configured to deliver heat.

In at least one embodiment, the vessel including a top thermal shield.

In at least one embodiment, the vessel comprises a side thermal shield.

Typically, the vessel comprises a box including a connector attaching to the jacket, the connector carrying sensing probes to allow accurate control of energy injection process, thereby increasing efficiencies and the convenience of operation.

In at least one embodiment, the jacket is a solar thermal pre-designed heat retention jacket.

In at least one embodiment, the jacket is a vacuum thermal pre-designed heat retention jacket.

In at least one embodiment, the jacket is a mylar sheet jacket.

Typically, the jacket comprises sensing mechanisms selected from a group of mechanisms consisting of thermocouple temperature sensing mechanisms, infrared sensors, pressure sensors, resistance sensors.

Typically, the vessel is communicably coupled to at least a heat delivery mechanism, the heat delivery mechanism being selected from a group of mechanisms consisting of a conductive heat delivery mechanism, a convective heat delivery mechanism, a radiative heat delivery mechanism, and a generative heat delivery mechanism.

### BRIEF DESCRIPTION OF THE DRAWINGS

Example embodiments will now be described in relation to the accompanying drawings, in which:

FIG. 1 illustrates a vessel inside pre-designed jacket(s).

FIG. 2 illustrates a vessel with external heating.

FIG. 3 illustrates a vessel with internal heating.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

It will be understood that, although the terms first, second, etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments or methods. As used herein, the term “and/or” includes all combinations of one or more of the associated listed items. The use of “etc.” is defined as “et cetera” and indicates the inclusion of all other elements belonging to the same group of the preceding items, in any “and/or” combination(s).

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, the singular forms “a,” “an,” and “the” are intended to include both the singular and plural forms, unless the language explicitly indicates otherwise. It will be further understood that the terms “comprises,” “including,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof. The use of “about” in connection with values indicates effective approximation, and such values may vary within a range having substantially similar activity or functionality. As such, values referred to as “about” include similar values and precisions expected with applicable manufacturing tolerances and unavoidable impurities in the element of the value, and generally would be expected to vary less than 15% of the value itself.

The structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from single operations described below. It should be presumed that any embodiment or method having features and functionality described below, in any workable combination, falls within the scope of example embodiments.

The present invention is jacketed heat-retaining vessels. In contrast to the present invention, the few example embodiments and example methods discussed below illustrate just a subset of the variety of different configurations that can be used as and/or in connection with the present invention.

An object of example embodiments is to reduce consumption of energy required during a heating process.

Another object of example embodiments is to reduce cost involved in the heating process of a vessel or a utensil.

Yet another object of example embodiments is to prevent heat loss during heating process of a vessel or a utensil.

Still another object of example embodiments is to preserve heat loss during heating process of a vessel or a utensil and use this preserved loss to accelerate heating process.

Another object of example embodiments is to achieve clean-energy heating, thereby reducing indirect medical and social implications associated in the heating process.

According to example embodiments, there is provided a jacketed heat-retaining vessel.

This is achieved by trying to plug all the loss channels, viz, through conduction, convection, radiation, phase-change and mass-transfer. In addition, example embodiments try to ensure maximization of efficiency for heat generation and transfer to the cooking zone and medium or to a reaction zone where an example embodiment is placed.

In accordance with an example embodiment, there is provided a predesigned heat-retention jacket configured to ensconce/envelope a utensil. Typically, this is a passive heat-retaining jacket. The retention of heat within the jacket allows contents, in the vessel ensconced/enveloped within the jacket, to be continuously cooked even when it is not in communication with a direct source of heat. According to an exemplary embodiment, the vessel could be heated by any of the conventional means and then inserted into this predesigned jacket as soon as the contents reach boiling temperatures. Its vessel specific pre-designed configuration makes heat retention relatively higher.

Typically, the jacket comprises at least one layer of insulating material and at least one layer of radiation preventing material.

Preferably, the jacket comprises multiple layers of insulating material with radiation prevention layers interspersed between the insulating materials.

This radiation preventive layer is any reflective layer.

Heat loss due to conduction is stopped due to the insulating layer.

Heat loss due to convection is stopped due to close jacketing around the vessel.

Heat loss due to radiation is stopped due to the radiation prevention/reflective layer.

Heat loss due to mass transfer is prevented from escaping steam (which would otherwise carry away valuable energy out of the system), by ensuring steam is not generated or barely generated in the first place.

For most cooking processes, which have residual water (at the end of heating), such as boiling rice, pulses, stewing vegetables, or the like, the temperature of the vessel never goes much above 100 degrees Celsius. Under these cooking conditions a standard induction stove and a vessel may be used. In some other embodiments, other mechanisms of energy delivery can be used e.g. by hot fluids circulating in coils optical radiation, hot gases, steam, and the like.

This will allow added benefit of not having to touch any hot exposed metal part of the vessel. The heat-retaining jacket is kept all along, saving more energy, even during the heating-up process.

The jacket does not experience temperatures in excess of 100 degrees Celsius and therefore efficient material choices in the manufacture of the jacket can be exploited. (100 degrees Celsius maximum is only for boiling; as stated before other processes, such as frying, baking, and the like require higher temperature)

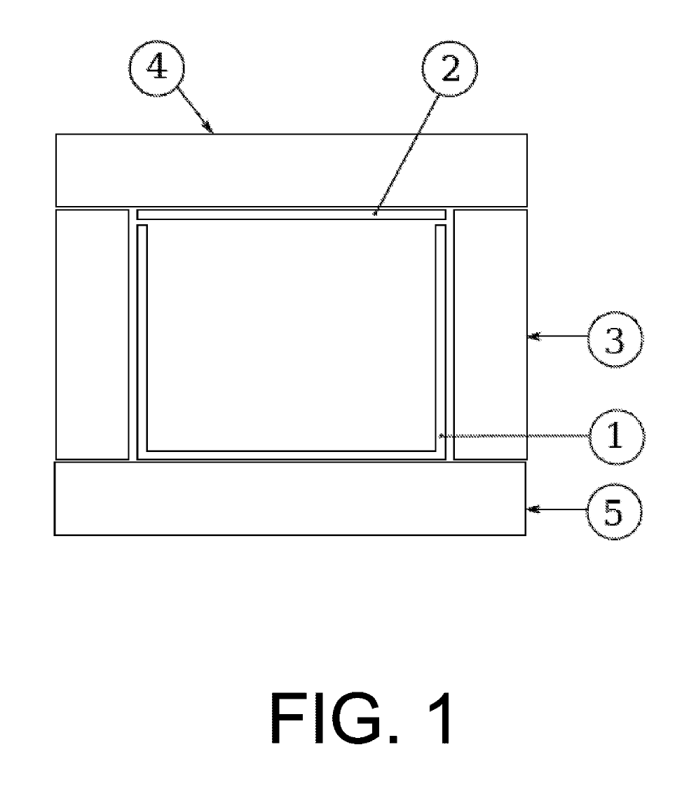

FIG. 1 illustrates a vessel inside pre-designed jacket(s). Reference numeral 1 refers to a Vessel/Pot. Reference numeral 2 refers to a Lid/Cover. Reference numeral 3 refers to a Side thermal shield of the pre-designed jacket. Reference numeral 4 refers to a Top thermal shield of the pre-designed jacket. Reference numeral 5 refers to a Bottom thermal shield of the pre-designed jacket.

Although open flames may not be the best process to transfer energy to the vessel and ingredients, this is currently a widely accepted process around the world.

In accordance with another embodiment, there is provided a vessel which is resistant to direct flames. Careful choice of materials ensures not only fire resistance, but also non-toxic and food-friendly materials and processes.

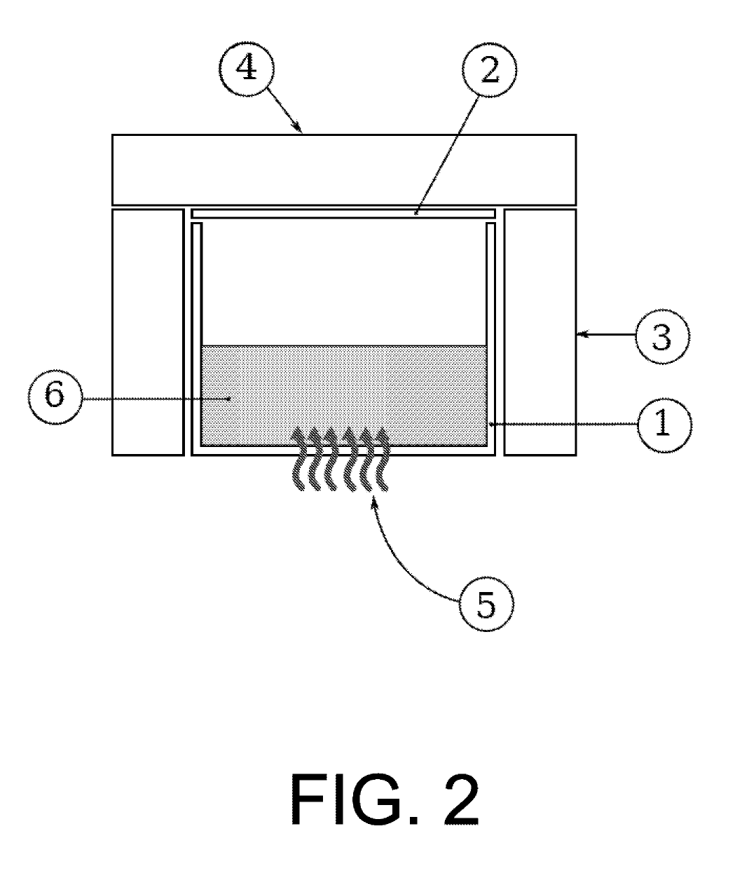

FIG. 2 illustrates a vessel with external heating. Reference numeral 1 refers to a Vessel/Pot. Reference numeral 2 refers to a Lid/Cover. Reference numeral 3 refers to a Side thermal shield. Reference numeral 4 refers to a Top thermal shield. Reference numeral 5 refers to an External heating source. Reference numeral 6 refers to a Heated matter.

Standard induction stove based heating still has problems of losses through the lower surface of the vessel (which is in close proximity to the induction coils of the stove). All other surfaces will have the heat-retention shields of the predesigned jacket. Also, there is inefficiency of energy conversion with a standard induction stove to the vessel for cooking. There are losses in the coils as well as the electronics driver circuits.

In accordance with yet another embodiment, there is provided a bottom shield for the pre-designed heat-retention jacket which covers the stove or heat source as well.

In at least one other embodiment, the pre-designed heat retention jacket comprises embedded induction coils in order to provide heat to the ensconced//enveloped vessel.

The induction heating drivers are very energy efficient, and there are minimal losses for the process of radio-frequency generation to effect induction heating.

A separate box would have a connector attaching to the jacket. This connector could also carry temperature sensing probes to allow accurate control of energy injection process, thereby increasing efficiencies and the convenience of operation even more. Further, the connector could also carry pressure sensing probes to allow control based on changes in pressure.

Since the process of internal induction heating is more energy efficient, it can be used with energy obtained from Solar PV panels. A few solar PV panels, possibly put up as window shades on walls of apartment buildings that receive 3-4 hours of sunlight, along with battery storage, could allow a normal family's cooking energy needs for the full day and night be adequately satisfied.

In this form of solar cooking, one does not need to go out in the sun in the traditional and common description of solar cooking. Even people who stay in apartments in high-rises, or in congested slums, who do not have good access to open areas to put traditional solar cookers, could use the Solar PV along with example embodiments to good advantage.

The left over energy in the battery could easily be used for lighting or other small applications, say running one's laptop. In any case, when there is no sunlight (say during Monsoons and overcast days), the electronics could be run with standard household power as well. Thermal storage mechanisms, particularly for larger systems, could also cope with periods of no sunlight, say during certain monsoon days.

A modified version of the solar panel, which can be used to also heat water will come in as an even better version. Normal solar PV panels are around 12-15% efficient. This means that nearly 80+ of incident energy is wasted as heat in the panel (they can get very hot). If instead, normal solar panels are modified to also act as a hot surface and heat water or oil, and store it in insulated tanks for later use, then we can make even more energy efficient example embodiment vessel. This hot water (or oil which could in turn heat water) will ensure that we can start the cooking process, say boiling, with water not at 25-30 degree Celsius, but say at 60-70 degrees Celsius. This way the solar PV energy needs to only boost the temperature by around 30 degrees Celsius, as opposed to from room temperature. This will likely more than halve the input energy requirement, resulting in the need for smaller battery and solar panel. Hence, lowering the cost on this front. The added complexity of a heat exchanger and a tank to store hot fluid, and a slight modification of the cooking process itself needs to be accommodated.

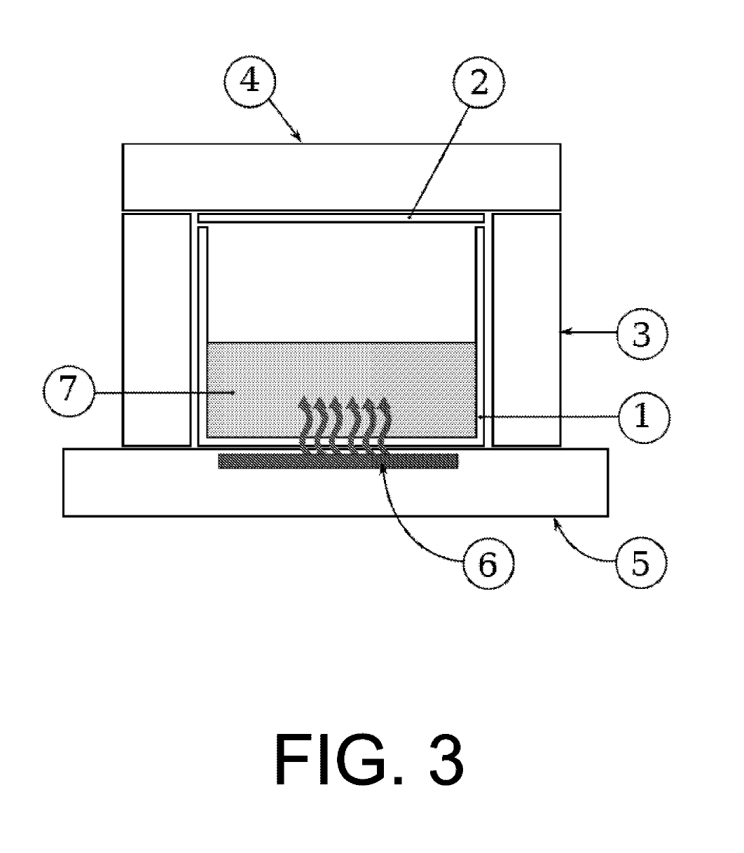

FIG. 3 illustrates a vessel with internal heating. Reference numeral 1 refers to a Vessel/Pot. Reference numeral 2 refers to a Lid/Cover. Reference numeral 3 refers to a Side thermal shield. Reference numeral 4 refers to a Top thermal shield. Reference numeral 5 refers to a Bottom thermal shield. Reference numeral 6 refers to an Internal heating source. Reference numeral 7 refers to a Heated matter.

In accordance with still another embodiment, there is provided a solar thermal pre-designed heat retention jacket.

Normal household solar hot-water panels would heat water to around 60 to 80 degrees Celsius. With water as the thermic fluid, one cannot exceed 100 degrees, since water would change to steam. However, if one used other thermic fluids, say certain oils, then temperatures in the range of 150-170 degrees or higher is possible. Of course with larger scale, industrial solar heating systems, this would not be an issue. If heat could be injected directly inside the heat-retaining jackets, then all types of cooking can be done with solar thermal power alone. In at least one embodiment, maximum temperatures achieved is close to 300 degrees Celsius.

In accordance with still another embodiment, there is provided a vacuum thermal pre-designed heat retention jacket.

Certain cooking processes involve thickening of food by removal of water. One example traditionally, to create basundi or rabdi (condensed milk) is to heat and boil off the water. A better process may be to allow the “boiling” to happen at lower temperatures, by reducing the atmospheric pressure, or creating partial vacuum. Water would evaporate at lower temperature, thickening the milk for example.

If this process is carried out in a using an example embodiment vessel, the process of evaporation would also cool the liquid. This may be an added bonus, to keep things refrigerated. Often such milk products need to be chilled to help preservation.

In at least one embodiment, the heat retaining jackets can be made of mylar sheets.

There are several salient advantages of example embodiments, which manifest in its various implementations:
1. Lower energy cost: Even if one conservatively estimates that half of conventional energy usage could be saved. This would amount to at least s.300-500 per month of saving for an average household. The cost of owning an energy efficient pot could therefore be recovered in a matter of months. Any additional savings is a saving for the individuals using it, in terms of fuel cost. Society at large benefits too, in terms of reduced fossil fuel usage.
2. Hot-pack property: If food cooked may be kept hot or warm for a long time, it can be a definite advantage. Not only does it save re-heating time and energy, but also allows one to make food a smaller number of times, say at homes, restaurants, etc. If say rice is cooked and can be served hot even hours later, then it saves the trouble of having to cook rice on the fly, or make assumptions about consumption patterns in a restaurant for example.
3. Remote location usage: The lower energy requirement to cook food, can potentially allow one to cook food with relatively meagre sources of energy, perhaps even obtained from alternate energy sources. Traditionally, cooking using alternate energy was considered inadequate and therefore difficult. The ability to have very modest inputs of energy and still be able to cook food adequately, would allow one to cook practically anywhere, and not be tied up with conventional fuels and their consumption quantum.
4. Retro fitting: Potentially, example embodiments can be adapted to already existing pots, satisfying certain geometric constraints. In principle one could take one's favourite pots and make it compatible with example embodiments.
5. Cleaning/Hygiene: Example embodiments will be designed to make them inherently easier to clean, thereby maintaining the standards of hygiene demanded in a cooking environment and equipment.

Although example embodiments are described in relation to cooking utensils, it is to be understood that it is not just for cooking, but can be used as an efficient energy retaining container (say a tank of hot fluid). By the same token, the vessel can be treated as a heat efficient shield (say, for making better refrigerators or ice boxes or the like). Example embodiments can be used in similar processes such as in agro-processing, chemical industries, or the like.

While this detailed description has disclosed certain specific embodiments for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of example embodiments not as a limitation.

What is claimed is:

1. A jacketed heat-retaining vessel comprising:
a pre-designed heat-retention jacket configured to envelope a vessel, wherein, the heat-retention jacket includes,
embedded heat deliverers to provide heat to the enveloped vessel; and
at least one layer of insulating material and at least one layer of radiation reflective material alternatively interspersed along a radially outward direction from the vessel center.

2. The vessel of claim 1 wherein, the jacket includes a plurality of sheets of radiation reflective material in concentric configuration with respect to the vessel.

3. The vessel of claim 1 wherein, the jacket includes a plurality of sheets of radiation reflective material in a spiral configuration with respect to the vessel.

4. The vessel of claim 1 wherein, the radiation reflecting layer being formed in a continuous series of loops in a layered form about a cylindrical axis of the vessel.

5. The vessel of claim 1 wherein, the radiation reflecting layer being formed in a non-continuous series of loops in a layered form about a cylindrical axis of the vessel.

6. The vessel of claim 1 wherein, the insulating layer being formed in a continuous series of loops in a layered forms about a cylindrical axis of the vessel.

7. The vessel of claim 1 wherein, the insulating layer being formed in a non-continuous series of loops in a layered forms about a cylindrical axis of the vessel.

8. The vessel of claim 1 wherein, the jacket is a passive heat-retaining jacket.

9. The vessel of claim 1 wherein, the jacket includes multiple layers of insulating material with radiation reflective layers interspersed between the insulating materials.

10. The vessel of claim 1 wherein, the jacket includes at least one layer of insulating material and at least one layer of radiation reflective material, wherein, the radiation reflective layer is any reflective layer.

11. The vessel of claim 1 wherein, the vessel includes a bottom shield for the pre-designed heat-retention jacket which covers the embedded induction coils.

12. The vessel of claim 1 wherein, the vessel includes a bottom shield for the pre-designed heat-retention jacket which covers an energy source configured to deliver heat.

13. The vessel of claim 1 wherein, the vessel includes a top thermal shield.

14. The vessel of claim 1 wherein, the vessel includes a side thermal shield.

15. The vessel of claim 1 wherein, the vessel includes a box comprising a connector attaching to the jacket, the connector carrying sensing probes to allow accurate control of energy injection process, thereby increasing efficiencies and the convenience of operation.

16. The vessel of claim 1 wherein, the jacket is a solar thermal pre-designed heat retention jacket.

17. The vessel of claim 1 wherein, the jacket is a vacuum thermal pre-designed heat retention jacket.

18. The vessel of claim 1 wherein, the jacket is a mylar sheet jacket.

19. The vessel of claim 1 wherein, the jacket includes sensors selected from a group of consisting of thermocouple temperature sensors, infrared sensors, pressure sensors, and resistance sensors.

20. The vessel of claim 1 wherein, the vessel being communicably coupled to at least a heat deliverer selected from a group consisting of a conductive heat delivery mechanism, a convective heat delivery mechanism, a radiative heat delivery mechanism, and a generative heat delivery mechanism.
